(19) United States
(12) Patent Application Publication
(10) Pub. No.: US 2014/0305676 A1
(43) Pub. Date: Oct. 16, 2014

(54) DIFFERENTIAL SIGNAL TRANSMISSION CABLE AND MULTIPAIR DIFFERENTIAL SIGNAL TRANSMISSION CABLE

(71) Applicant: HITACHI METALS, LTD., Tokyo (JP)

(72) Inventors: Takahiro SUGIYAMA, Hitachi (JP); Yosuke ISHIMATSU, Hitachi (JP); Akinari NAKAYAMA, Hitachinaka (JP)

(73) Assignee: HITACHI METALS, LTD., Tokyo (JP)

(21) Appl. No.: 14/243,820

(22) Filed: Apr. 2, 2014

(30) Foreign Application Priority Data
Apr. 15, 2013 (JP) 2013-084834

(51) Int. Cl. H01B 11/00; H01B 7/02

(52) U.S. Cl. CPC H01B 11/002; H01B 7/02
USPC 174/108; 174/102 R

(57) ABSTRACT

A differential signal transmission cable includes two core wires arranged in parallel, each of the two core wires having an insulation layer on an outer periphery of a conductor; and an outer conductor provided so as to cover the two core wires all together. The insulation layer includes sequentially an inner skin layer of a non-foamed resin, a foam layer of a foamed resin, and an outer skin layer of a non-foamed resin on the outer periphery of the conductor. The outer skin layer has a higher relative permittivity than the inner skin layer. The multipair differential signal transmission includes a plurality of differential signal transmission cables and a protective jacket provided around the plurality of differential signal transmission cables.

The present application is based on Japanese Patent Application No. 2013-084834 filed on Apr. 15, 2013, the entire contents of which are incorporated herein by reference.

### BACKGROUND OF THE INVENTION

1. Field of the Invention

The invention relates to a differential signal transmission cable and a multipair differential signal transmission cable.

2. Description of the Related Art

A differential signal transmission cable 21 as shown in FIG. 2 has been conventionally known.

The conventional differential signal transmission cable 21 shown in FIG. 2 is configured such that two core wires 24 each of which comprises an insulation layer 23 on an outer periphery of a conductor 22 are arranged in parallel and an outer conductor 25 is provided so as to cover the two core wires 24 all together.

When using the insulation layer 23 including a foamed resin layer, the insulation layer 23 further includes generally non-foamed layers called “skin layers” at an inner portion in contact with the conductor 22 and at an outer portion in contact with the outer conductor 25. Hereinafter, the skin layer on the inner side is referred to as an inner skin layer 26, the skin layer on the outer side is referred to as an outer skin layer 28, and the foamed resin layer provided between the inner skin layer 26 and the outer skin layer 28 is referred to as a foam layer 27.

The inner skin layer 26 is provided to suppress a decrease in adhesion of the insulation layer 23 to the conductor 22 caused by accumulation of the air between the foam layer 27 and the conductor 22, and the outer skin layer 28 is provided to prevent water from entering the foam layer 27. The inner skin layer 26, the foam layer 27 and the outer skin layer 28 are generally formed of the same material with only difference in presence or degree of foaming, and the process of forming such a triple-layered insulation layer 23 is called three-layer co-extrusion, etc., and has been generally carried out.

The outer conductor 25 is formed by winding a conductive tape in which a metal layer is formed on one side of a tape-shaped resin. As a winding method, it is known that the conductive tape is laterally wound in a spiral manner or longitudinally wrapped.

It is known that, when the outer conductor 25 is formed by laterally winding the conductive tape, the resin layer and the metal layer are periodically arranged along a cable longitudinal direction and transmission characteristics deteriorate at a particular frequency. In order to suppress such a problem, the outer conductor 25 formed by longitudinally wrapping the conductive tape is desirably used for the differential signal transmission cable 21 which is used for high-speed transmission.

JP-A 2002-358841 is one of the prior art references related to the present invention.

In the meantime, the differential signal transmission cable 21 has two transmission modes: a differential mode to transmit differential signals through a pair of conductors 22; and a common mode to transmit common-mode signals through the pair of conductors 22.

During signal transmission in the differential mode, the electric field is concentrated in the vicinity of the conductors 22. Therefore, propagation velocity in the differential mode depends mainly on relative permittivity of the insulation layer 23 present between the conductors 22.

On the other hand, during signal transmission in the common mode, the electric field is concentrated between the conductors 22 and the outer conductor 25. Therefore, propagation velocity in the common mode depends on relative permittivity of the insulation layer 23 present between the conductors 22 and the outer conductor 25.

In the differential signal transmission cable 21, there is a gap (referred to as “air layer 29”) between the two core wires 24 and the outer conductor 25. Since a large portion of the air layer 29 is present in the vicinity of the outer conductor 25, the common mode is more likely to be affected thereby as compared to the differential mode. This causes the propagation velocity in the common mode to be faster than that in the differential mode, resulting in different propagation velocity between the differential mode and the common mode. In other words, skew between the differential and common modes occurs in the differential signal transmission cable 21.

Ideally, the skew between the differential and common modes does not affect on transmission characteristics since differential signals are mainly used in high transmission. However, when mutual coupling from the differential mode to the common mode or from the common mode to the differential (differential- and common-mode coupling (SCD21, SDC21)) occurs, such as when symmetry of the cable structure is lost due to manufacturing variations, there is a problem in that transmission characteristics (skew characteristics of differential signals) deteriorate due to the skew between the differential and common modes.

In the case that the outer conductor 25 is formed by laterally winding the conductive tape, no significant problem occurs in many cases because the in-phase component attenuates. However, the high-speed differential signal transmission cable 21 in which the outer conductor 25 is formed by longitudinally wrapping the conductive tape is likely to be affected by the skew between the differential and common modes since the in-phase component is transmitted without attenuation and transmission characteristics significantly deteriorate due to the differential- and common-mode coupling.

Since it is difficult to completely eliminate the differential- and common-mode coupling, a differential signal transmission cable allowing deterioration in transmission characteristics to be suppressed even in the event of the differential- and common-mode coupling is desired.

### SUMMARY OF THE INVENTION

The invention is made in view of such circumstances and it is an object of the invention to provide a differential signal transmission cable and a multipair differential signal transmission cable which allows deterioration in transmission characteristics to be suppressed even in the event of differential- and common-mode coupling.

(1) According to a feature of the invention, a differential signal transmission cable, comprises:

two core wires arranged in parallel, each of the two core wires comprising an insulation layer on an outer periphery of a conductor; and

an outer conductor provided so as to cover the two core wires all together,

wherein the insulation layer comprises sequentially an inner skin layer comprising a non-foamed resin, a foam layer comprising a foamed resin, and an outer skin layer comprising a non-foamed resin on the outer periphery of the conductor,

wherein the outer skin layer has a higher relative permitittivity than the inner skin layer.

In the above embodiment (1) of the invention, the following modifications and changes can be made.

(i) The relative permittivity of the outer skin layer is not less than 3.

(ii) The outer skin layer is thicker than the inner skin layer.

(iii) The inner skin layer has a thickness of not more than 0.1 mm.

(iv) The outer conductor comprises a conductive tape longitudinally wrapped around an outer periphery of the two core wires.

(v) The outer skin layer comprises one of an ethylene-vinyl acetate resin, a polyamide resin and a polyester resin.

(vi) The inner skin layer comprises a non-foamed polyethylene, the foam layer comprises a foamed polyethylene and the outer skin layer comprises a non-foamed polyethylene with an inorganic material added thereto.

(vii) The inorganic material is silica.

(2) According to another feature of the invention, a multipair differential signal transmission cable, comprises:

a plurality of differential signal transmission cables; and

a protective jacket provided around the plurality of differential signal transmission cables,

wherein each of the differential signal transmission cables comprises two core wires arranged in parallel and each of the two core wires comprises an insulation layer on an outer periphery of a conductor and an outer conductor provided so as to cover the two core wires all together,

wherein the insulation layer comprises sequentially an inner skin layer comprising a non-foamed resin, a foam layer comprising a foamed resin and an outer skin layer comprising a non-foamed resin on the outer periphery of the conductor,

wherein the outer skin layer has a higher relative permittivity than the inner skin layer.

In the above embodiment (2) of the invention, the following modifications and changes can be made.

(i) The relative permittivity of the outer skin layer is not less than 3.

(ii) The outer skin layer is thicker than the inner skin layer.

(iii) The inner skin layer has a thickness of not more than 0.1 mm.

(iv) The outer conductor comprises a conductive tape longitudinally wrapped around an outer periphery of the two core wires.

(v) The outer skin layer comprises one of an ethylene-vinyl acetate resin, a polyamide resin and a polyester resin.

(vi) The inner skin layer comprises a non-foamed polyethylene, the foam layer comprises a foamed polyethylene and the outer skin layer comprises a non-foamed polyethylene with an inorganic material added thereto.

(vii) The inorganic material is silica.

### Points of the Invention

According to the invention, it is possible to provide a differential signal transmission cable and a multipair differential signal transmission cable which allows deterioration in transmission characteristics to be suppressed even in the event of differential- and common-mode coupling.

### BRIEF DESCRIPTION OF THE DRAWINGS

Next, the present invention will be explained in more detail in conjunction with appended drawings, wherein:

FIG. 1 is a cross sectional view showing a differential signal transmission cable in an embodiment of the present invention; and

FIG. 2 is a cross sectional view showing a conventional differential signal transmission cable.

### DETAILED DESCRIPTION OF THE EMBODIMENTS

An embodiment of the invention will be described below in conjunction with the appended drawings.

### Differential Signal Transmission Cable

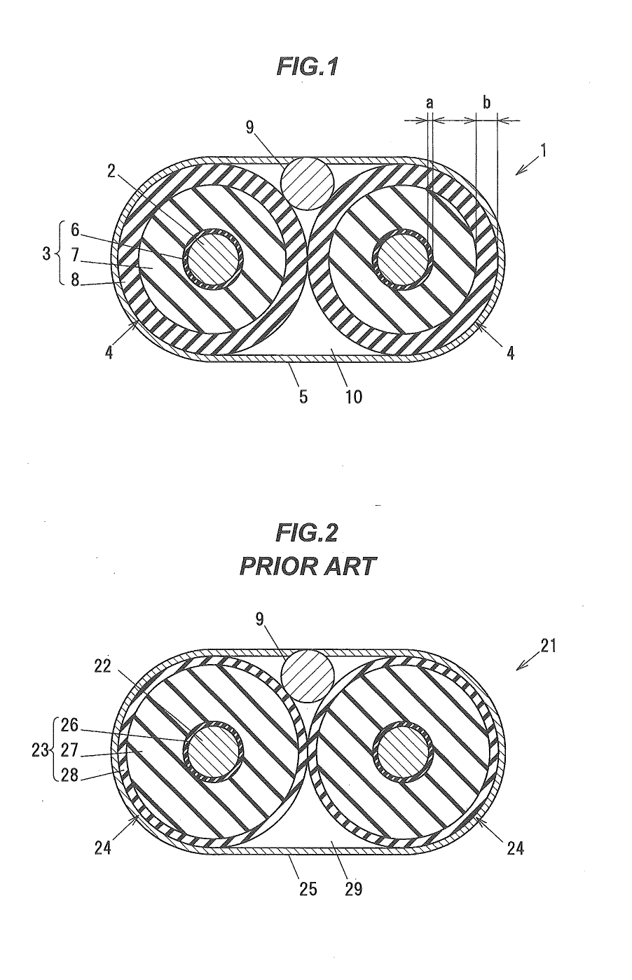

FIG. 1 is a cross sectional view showing a differential signal transmission cable in the present embodiment.

As shown in FIG. 1, a differential signal transmission cable 1 is configured such that two core wires 4 each of which comprises an insulation layer 3 on an outer periphery of a conductor 2 are arranged in parallel and an outer conductor 5 is provided so as to cover the two core wires 4 all together.

The insulation layer 3 is formed by sequentially providing an inner skin layer 6 formed of a non-foamed resin, a foam layer 7 formed of a foamed resin and an outer skin layer 8 formed of a non-foamed resin on the outer periphery of the conductor 2.

A drain wire 9 for grounding the outer conductor 5 is provided between the two core wires 4 and the outer conductor 5. Note that, the drain wire 9 is not essential and can be omitted.

A conductive tape, in which a metal layer or copper or aluminum, etc., is formed on one side of a tape-shaped resin, is longitudinally wrapped around an outer periphery of the two core wires 4, thereby forming the outer conductor 5.

In the present embodiment, the outer diameter of the conductor 2 is 0.511 mm, the outer diameter of the core wire 4 is 1.5 mm, the thickness of the inner skin layer 6 is 0.05 mm and characteristics impedance is set to 100Ω. A gap (referred to as “air layer 10”) is formed between the two core wires 24, the outer conductor 25 and the drain wire 9.

The inner skin layer 6 and the foam layer 7 formed of the same resin are used in the same manner as the conventional technique. Here, a non-foamed polyethylene (PE) having a relative permittivity of 2.1 is used for the inner skin layer 6 and a foamed PE having a relative permittivity of 1.6 is used for the foam layer 7.

In the differential signal transmission cable 1 of the present embodiment, the relative permittivity of the outer skin layer 8 is higher than that of the inner skin layer 6. Since the relative permittivity of the foam layer 7 is lower than that of the inner skin layer 6, the ascending order of the relative permittivity in the differential signal transmission cable 1 is the foam layer 7, the inner skin layer 6 and the outer skin layer 8.

The common mode in which the electric field is concentrated between the conductors 2 and the outer conductor 5 is more likely to be affected by the relative permittivity of the outer skin layer 8 than the differential mode in which the electric field is concentrated between the conductors 2. Therefore, in the present embodiment, the relative permittivity of the outer skin layer 8 is increased to suppress the influence of the air layer 10 having a low relative permittivity, thereby suppressing occurrence of a difference in propagation velocity, i.e., skew, between the differential mode and the common mode.

In the meantime, both the relative permittivity and thickness a of the outer skin layer 8 have an affect on the propagation velocity in the common mode. That is, when the relative permittivity of the outer skin layer 8 is increased, it is possible to suppress skew even if the thickness a of the outer skin layer 8 is reduced. On the other hand, when the thickness a of the outer skin layer 8 is increased, it is possible to suppress skew even if the relative permittivity of the outer skin layer 8 is reduced.

In this regard, however, the relative permittivity of the outer skin layer 8 is desirably not less than 3. This is because, in case of using a general resin such as PE for the inner skin layer 6 and the foam layer 7, it is difficult to balance the propagation velocity between the differential mode and the common mode even if the thick outer skin layer 8 is formed when the relative permittivity of the outer skin layer 8 is less than 3.

In addition, the thickness a of the outer skin layer 8 is desirably greater than a thickness b of the inner skin layer 6. The inner and outer skin layers in a conventional cable are generally not more than 0.1 mm in thickness. However, providing the outer skin layer 8 having the thickness a equivalent thereto arises a need of using a material having a very high relative permittivity, hence, not realistic. Therefore, when the thickness b of the inner skin layer 6 is a typical thickness of not more than 0.1 mm, the thickness a of the outer skin layer 8 is desirably greater than the thickness b of the inner skin layer 6.

In the present embodiment, the outer skin layer 8 is formed of EVA (ethylene-vinyl acetate) resin adjusted to have a relative permittivity of 3.2 and the thickness a of the outer skin layer 8 is 0.2 mm. The thickness a of the outer skin layer 8 here is about 40% of the total thickness of the insulation layer 3 and is about 27% of the radius of the core wire 4.

Note that, the resin used for the outer skin layer 8 is not limited to EVA as long as it has good adhesion to the resin (PE) used for the inner skin layer 6 and the foam layer 7, allows extrusion molding and has a relative permittivity of not less than 3, and it is also possible to use, e.g., polyamide resins such as nylon and polyester resins, etc. Alternatively, for the outer skin layer 8, it is possible to use the same resin as that used for the inner skin layer 6 and the foam layer 7 (in this case, PE) of which relative permittivity is adjusted by adding an inorganic material such as silica.

### Multipair Differential Signal Transmission Cable

A multipair differential signal transmission cable of the invention is obtained by providing a protective jacket around plural differential signal transmission cables 1 of the invention. It should be noted that not all of the differential signal transmission cables included in the multipair differential signal transmission cable need to be the differential signal transmission cable 1 of the invention and the invention includes any multipair differential signal transmission cables in which one of the differential signal transmission cables is the differential signal transmission cable 1.

In the differential signal transmission cable 1 of the present embodiment, the outer skin layer 8 has a higher relative permittivity than the inner skin layer 6, as described above.

By increasing the relative permittivity of the outer skin layer 8, it is possible to increase effective permittivity in the common mode, i.e., to compensate the low relative permittivity of the air layer 10 with the high relative permittivity of the outer skin layer 8 and it is this possible to equalize (or approximate) the effective permittivity in the differential mode and that in the common mode. As a result, it is possible to equalize (or approximate) propagation velocity in the differential mode and that in the common mode, which suppresses the skew between the differential and common modes and the resulting deterioration in transmission characteristics such as disturbance of waveform even when the differential- and common-mode coupling occurs due to manufacturing variations.

In the conventional differential signal transmission cable, the relative permittivity of the insulation layer 3 is generally reduced as much as possible in order to reduce dielectric loss. On the contrary, in the present embodiment, the skew between the differential and common modes is suppressed by increasing the relative permittivity of the outer skin layer 8 as well as forming the thicker outer skin layer 8 than the conventional art.

The invention is significantly effective especially when using the longitudinally-wrapped type of outer conductor 5 in which the in-phase component is transmitted without attenuation.

The present invention is not intended to be limited to the embodiment, and it is obvious that the various kinds of modifications can be implemented without departing from the gist of the invention.

Although the longitudinally-wrapped type of outer conductor 5 is used in the embodiment, it is not limited thereto. The laterally-wound type may be used.

What is claimed is:

1. A differential signal transmission cable, comprising:
two core wires arranged in parallel, each of the two core wires comprising an insulation layer on an outer periphery of a conductor; and
an outer conductor provided so as to cover the two core wires all together,
wherein the insulation layer comprises sequentially an inner skin layer comprising a non-foamed resin, a foam layer comprising a foamed resin, and an outer skin layer comprising a non-foamed resin on the outer periphery of the conductor,
wherein the outer skin layer has a higher relative permittivity than the inner skin layer.

2. The differential signal transmission cable according to claim 1, wherein the relative permittivity of the outer skin layer is not less than 3.

3. The differential signal transmission cable according to claim 1, wherein the outer skin layer is thicker than the inner skin layer.

4. The differential signal transmission cable according to claim 3, wherein the inner skin layer has a thickness of not more than 0.1 mm.

5. The differential signal transmission cable according to claim 1, wherein the outer conductor comprises a conductive tape longitudinally wrapped around an outer periphery of the two core wires.

6. The differential signal transmission cable according to claim 1, wherein the outer skin layer comprises one of an ethylene-vinyl acetate resin, a polyamide resin and a polyester resin.

7. The differential signal transmission cable according to claim 1, wherein the inner skin layer comprises a non-foamed polyethylene, the foam layer comprises a foamed polyethylene and the outer skin layer comprises a non-foamed polyethylene with an inorganic material added thereto.

8. The differential signal transmission cable according to claim 7, wherein the inorganic material is silica.

9. A multipair differential signal transmission cable, comprising:
a plurality of differential signal transmission cables; and
a protective jacket provided around the plurality of differential signal transmission cables,
wherein each of the differential signal transmission cables comprises two core wires arranged in parallel and each of the two core wires comprises an insulation layer on an outer periphery of a conductor and an outer conductor provided so as to cover the two core wires all together,
wherein the insulation layer comprises sequentially an inner skin layer comprising a non-foamed resin, a foam layer comprising a foamed resin and an outer skin layer comprising a non-foamed resin on the outer periphery of the conductor,
wherein the outer skin layer has a higher relative permittivity than the inner skin layer.

10. The multipair differential signal transmission cable according to claim 9, wherein the relative permittivity of the outer skin layer is not less than 3.

11. The multipair differential signal transmission cable according to claim 9, wherein the outer skin layer is thicker than the inner skin layer.

12. The multipair differential signal transmission cable according to claim 11, wherein the inner skin layer has a thickness of not more than 0.1 mm.

13. The multipair differential signal transmission cable according to claim 9, wherein the outer conductor comprises a conductive tape longitudinally wrapped around an outer periphery of the two core wires.

14. The multipair differential signal transmission cable according to claim 9, wherein the outer skin layer comprises one of an ethylene-vinyl acetate resin, a polyamide resin and a polyester resin.

15. The multipair differential signal transmission cable according to claim 9, wherein the inner skin layer comprises a non-foamed polyethylene, the foam layer comprises a foamed polyethylene and the outer skin layer comprises a non-foamed polyethylene with an inorganic material added thereto.

16. The multipair differential signal transmission cable according to claim 15, wherein the inorganic material is silica.
